(19) United States
(12) Patent Application Publication
(10) Pub. No.: US 2019/0052969 A1
(43) Pub. Date: Feb. 14, 2019

(54) Adjustable-Angle Asymmetric High Frequency Acoustic Device

(71) Applicant: Kang Gu, Beijing (CN)

(72) Inventor: Kang Gu, Beijing (CN)

(21) Appl. No.: 15/675,044

(22) Filed: Aug. 11, 2017

(51) Int. Cl. H04R 7/02; H04R 1/28; H04R 1/30; H04R 1/02

(52) U.S. Cl. CPC H04R 7/02; H04R 1/021; H04R 1/30; H04R 1/2865

(57) ABSTRACT

The invention is an adjustable-angle asymmetric high frequency acoustic horn loudspeaker, which provides projection angle adjustment for a horizontal plane from divided slot opening end of the invention horn loudspeaker. The invention horn loudspeaker can be used alone or as part of an array.

### FIELD OF THE INVENTION

The present invention relates to a high frequency horn loudspeaker, which can be alone or in an array.

### BACKGROUND OF THE INVENTION

A kind of column-shaped acoustic horn is available in the prior art, whose structure includes a rectangular slot at a top end of a housing which has with a circular inlet opening. The circular inlet opening is fixed to an acoustic high frequency driver, which inlet opening extends upward to a round to rectangular transition, with the rectangular outlet opening at a top end. It is well known that directionality of horn loudspeakers aids in limiting audio reflections while achieving a room filling sound quality. Horn loudspeakers are commonly used as midrange and tweeter speaker in high power sound reinforcement loudspeakers. The acoustic horns are often used in a side by side array with similar or identical acoustic horns, each separated from the other by some sort of divider.

Problems are experienced in prior art column-shaped acoustic horn loudspeakers:

1) If a user desires, referenced from a direction axis from centers of the throat to the mouth of the horn loudspeaker, to expand a desired directional cross-section transmission area about the direction axis, the prior art requires that an entirely different horn loudspeaker be added or used, i.e., there is no flexibility for the user at to the projection angle once the entire loudspeaker is fabricated.

2) To achieve a more generally desired overall sound experience from a loudspeaker, horn loudspeakers are not provided with projection angles less than about 30 degrees to the direction axis and at the mouth of the horn loudspeakers. This results in acoustical interference among the adjacent horn loudspeakers in an array.

There is a need for a horn loudspeaker with adjustable projection angles.

### SUMMARY OF THE INVENTION

The invention is an adjustable-angle asymmetric high frequency acoustic horn loudspeaker, which provides projection angle adjustment for a horizontal plane from divided slot opening end of the invention horn loudspeaker. The invention horn loudspeaker can be used alone or as part of an array.

For the invention asymmetric high frequency horn loudspeaker, a first adjustable half comprises hinged doors of a specific arcuate configuration as a means to change the projection angle of one half of the acoustic driver output from a relatively small projection angle, resulting in a long “throw” for a more distant set audience, to a relatively large projection angle, resulting in a shorter “throw” for a nearer audience. Similarly, a second adjustable half of the invention horn loudspeaker comprises a second set of hinged doors of a different specific arcuate configuration as a means to change the projection angle of one half of the acoustic driver output from a relatively small projection angle, resulting in a long “throw” for a more distant set audience, to a relatively large projection angle, resulting in a shorter “throw” for a nearer audience.

The invention generally comprises:

A transition horn attached at a throat end to a mid-range or high frequency acoustic driver and fixed and sealed to a distributor housing at a mouth end, where an inside surface of the transition horn extends up from the throat end to the mouth end with a concave arcuate shape resulting in a mouth opening smaller than the throat opening in a manner well known to be related to the frequencies which are to be emitted from the acoustic driver;

A conical core with concave, arcuate conical surface fixed so that surface is generally equidistant from the inside surface of the transition horn at a distance of from 10 mm to 100 mm, thereby forming an annular opening at a top rim of the transition horn and the conical core.

An asymmetric diverter has a first diverter half and a second diverter half. Each of the diverter halves is arranged along a horizontal axis and divided at half its length into the diverter halves by a dividing plane normal to that axis. The asymmetric diverter is fixed at its halfway length at a bottom surface to a circular top surface of the conical core at a center of that top surface. This results in diversion of sound waves that are transmitted through the annular space of the transition horn and upward through the annular opening between the top rim of the transition horn and the conical core. As the conical core's conical outside surfaces face down, each diverter half comprises outside surfaces continuing and facing upward from the conical core. Those diverter half outside surfaces are spaced apart from but generally conform to inside surfaces of adjustable doors of a speaker housing. In one diverter half, the diverter surfaces are convex and adapted to further divide the received audio output. In the other diverter half, the diverter surfaces are concave and adapted to further divide the received audio output. The divided audio output transmitted around the first diverter half is recombined and emitted from a first slot opening. The divided audio output transmitted around the second diverter half is recombined and emitted from a second slot opening.

The adjustable doors of the speaker housing are arranged to define two long edges of two rectangular slot openings from which it emitted the recombined audio output transmitted about the diverter halves. The adjustable doors are in opposing pairs and hinged generally parallel to a lengthwise axis of the diverter halves, resulting in an arrangement where the doors may be opened away from the lengthwise axis of the diverter halves to increase the projection angle of one half or all of the audio output transmitted around the diverter halves. In reverse, the adjustable doors may be moved toward each other to restrict the projection angle of the slot openings.

The invention includes the following merits:

1. It can be used in common sound boxes for meetings; it achieves its highest service efficiency in meeting rooms; through left/right adjustment by adjustable doors, sound box squeak can be reduced in the range of 800 Hz-16 kHz.

2. It can be used in line array sound boxes; with use of the device, the adjustable doors allow for a projection angle of above 120 degrees.

3. While used in common sound boxes, square sound reinforcement can produce a high degree of uniformity of front and back sound.

4. When the device is used in a common sound box, any angle of the sound box can set in the left, right, upward (a lower adjustable door is kept in a closed position; an upper adjustable door is moved to an open position) or downward (an upper adjustable door is kept in a closed position; a lower adjustable door is moved to an open position) direction according to desired sound quality for the room.

### BRIEF DESCRIPTION OF THE DRAWINGS

FIG. 1 is a side view of the invention adjustable-angle asymmetric high frequency acoustic device.

FIGS. 2, 3, 4 and 5 show respectively side, cutaway, bottom and top views of a transition horn of FIG. 1.

FIGS. 6 and 7 respectively show side and bottom views of a conical core of the device of FIG. 1.

FIG. 8 shows the conical core of FIG. 1 fixed in the transition horn of FIG. 3.

FIGS. 9, 10, 11 and 12 show respectively top, side, left and right views of an asymmetric diverter of the invention.

FIGS. 13, 14 and 15 show the asymmetric diverter of FIG. 10 fixed to a top of the conical core of FIG. 6.

FIGS. 16, 17, 18 and 19 respectively show top, side, left and right views of the speaker housing of FIG. 1.

FIG. 20 shows the speaker housing of FIG. 16 with certain cross-sections.

FIGS. 22 and 23 are respectively the views of FIGS. 18 and 19 for reference with the associated drawing figures.

FIG. 24 is cross-section 49 of FIG. 20 showing adjustable doors in a closed position.

FIG. 25 is the cross-section of FIG. 24 showing adjustable doors in an open position.

FIG. 26 is cross-section 50 of FIG. 20 showing adjustable doors in a closed position.

FIG. 27 is the cross-section of FIG. 26 showing adjustable doors in an open position.

FIG. 28 is a cutaway view of FIG. 1.

FIGS. 29, 30, 31 and 32 are respectively the views of FIGS. 26, 27, 24 and 25 adding a conical core to the asymmetric diverter.

FIG. 33 is the device of FIG. 29 showing the wide angle, short throw aspect of the present invention.

FIG. 34 is the device of FIG. 31 showing the narrow angle, long throw aspect of the present invention.

### DETAILED DESCRIPTION OF THE INVENTION

The invention is now discussed with reference to the figures.

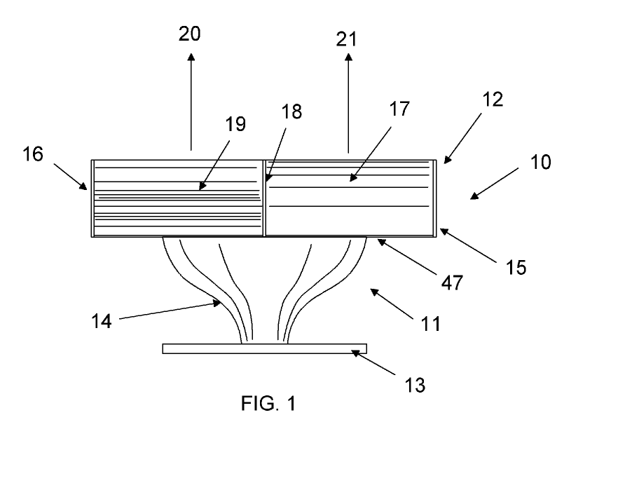

FIG. 1 is a side view of the invention adjustable-angle asymmetric high frequency acoustic device 10 comprising a transition horn 11 that has a base 13 and horn section 14. Speaker housing 12 comprises ends 15 and 16 joined at a bottom plate 47, from which at a center point extends upward divider wall 18. As will be described later, hinges at the vertices of the ends 16 and 16 and the divider wall 18 provide hinging attachment of adjustable doors 17 and 19 that partly define upward facing slot openings allowing audio output 20 and 21 to be directed to a desired listening audience.

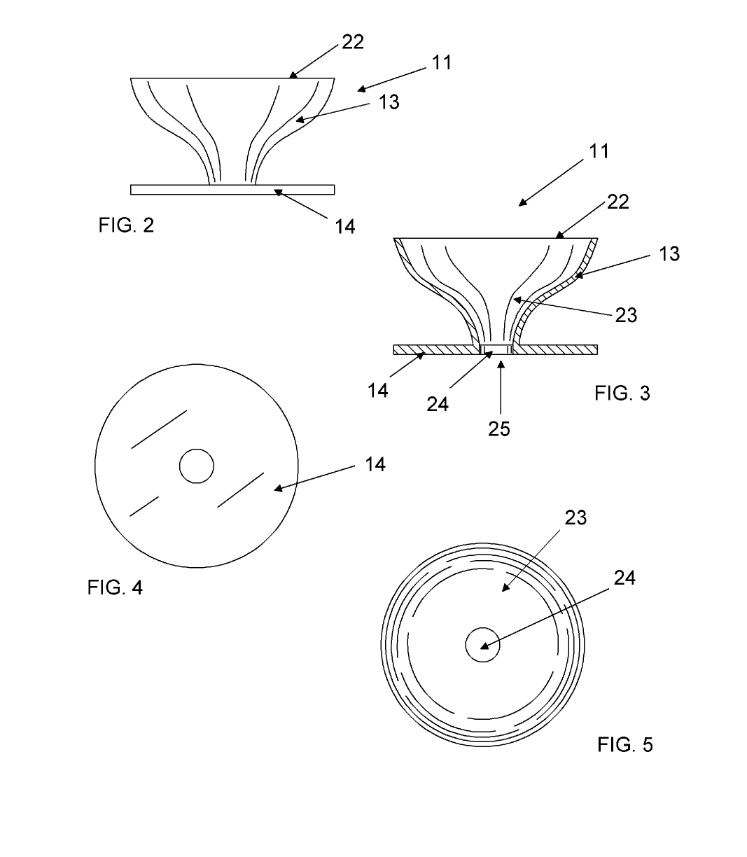

FIGS. 2, 3, 4 and 5 show respectively side, cutaway, bottom and top views of a transition horn 13 of FIG. 1, where a top rim 22 (defining a mouth opening for the horn) is at a highest elevation, descending internally from which is inside surface 23 in horn section 13. Base 14 defines a throat opening for the horn, which connects with the output opening for an acoustic driver (not shown). Inside surface 23 is preferably S-shaped, but may be concave or convex alone.

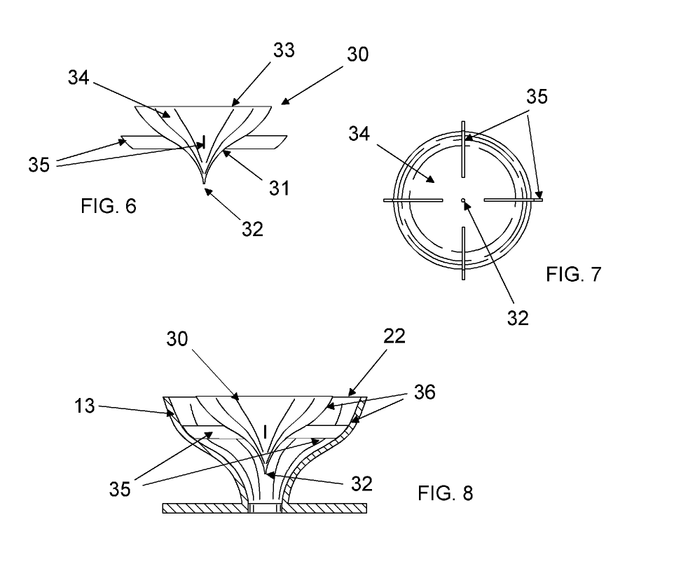

FIGS. 6 and 7 respectively show side and bottom views of a conical core 30 having S-shaped, arcuate conical sides 34 on a lower portion 31, which sides 34 generally conform to the S-shape of the inside surface 23 of the transition horn 13 (FIG. 3). Referring again to FIGS. 6 and 7, flanges 35 extend outward from sides 34 to support conical core 30 within the transition horn 13, as in FIG. 8, so that tip 32 is directed down, where a top 33 of conical core 30 is generally at the same elevation as top rim 22.

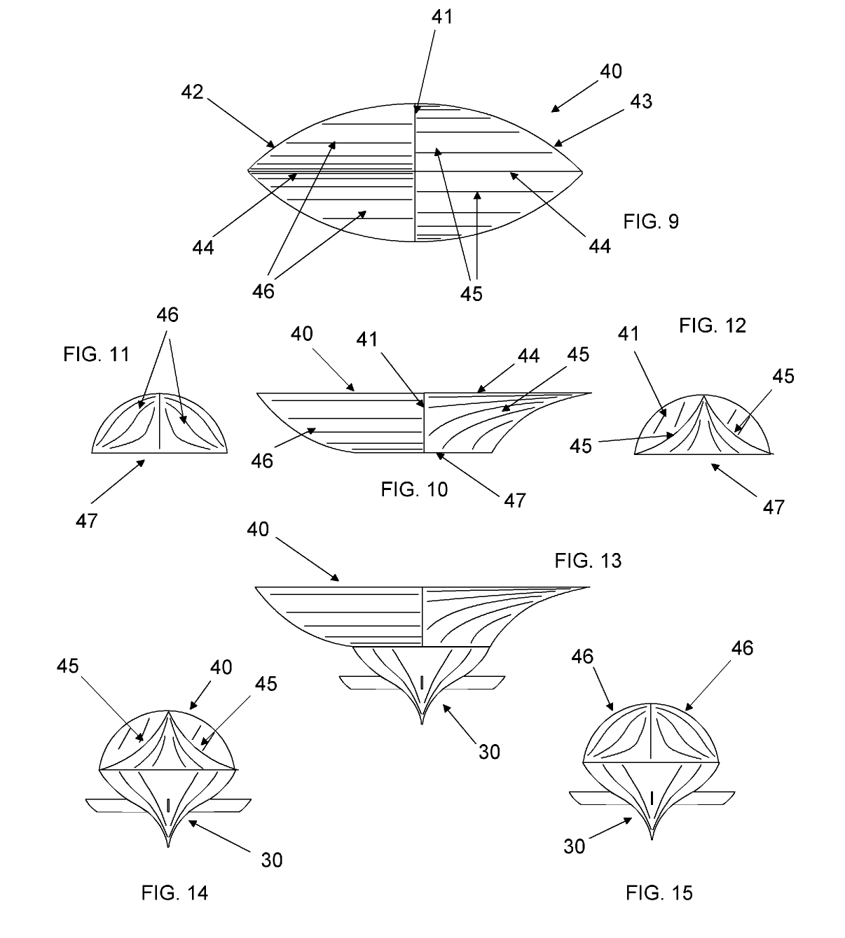

FIGS. 9, 10, 11 and 12 show respectively top, side, left and right views of an asymmetric diverter 40 of the invention, where a first diverter half 44 comprises two symmetric, concave, upward facing surfaces 46 and a second diverter half 43 comprises two symmetric, convex, upward facing surfaces 45. A dividing plane 41 divides at a half length of the asymmetric diverter (along a lengthwise axis). A top ridge 44 lies along a lengthwise symmetric dividing plane. FIGS. 13, 14 and 15 show the asymmetric diverter 40 of FIG. 10 fixed to a top of the conical core 30 of FIG. 6. The invention device is somewhat complex in concept and is shown in partial assembly for ease of understanding.

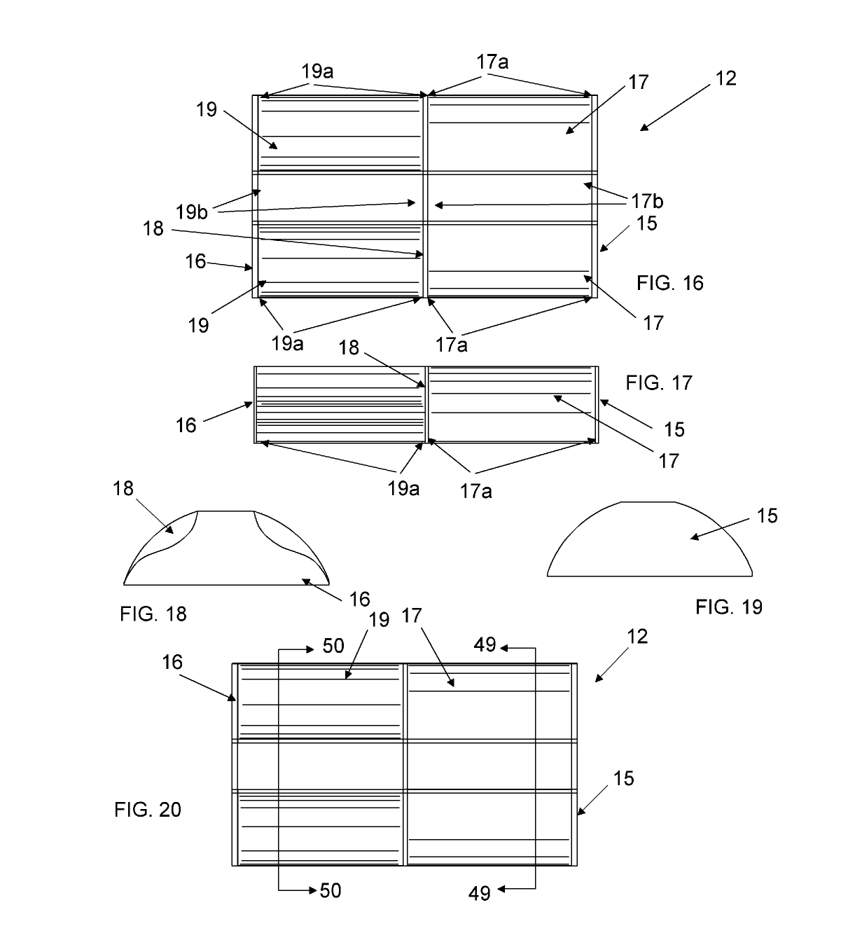

FIGS. 16, 17, 18 and 19 respectively show top, side, left and right views of the speaker housing 12 of FIG. 1, where ends 15 and 16 cooperate with divider wall 18 to provide hinge points 17a and 19a respectively for adjustable doors 17 and 19. End 15, divider wall 18 and top edges 17c of adjustable doors 17 define an opening slot 17b. End 16, divider wall 18 and top edges 19c of adjustable doors 19 define an opening slot 19b. It is apparent from inspection that doors 17 define a concave inside surface which will generally conform to and be spaced apart from the outside surfaces 46 of asymmetric divider 40 and doors 19 will generally conform to and be spaced apart from the outside surfaces 45 of asymmetric divider 40. FIG. 20 shows the speaker housing of FIG. 16 with certain cross-sections.

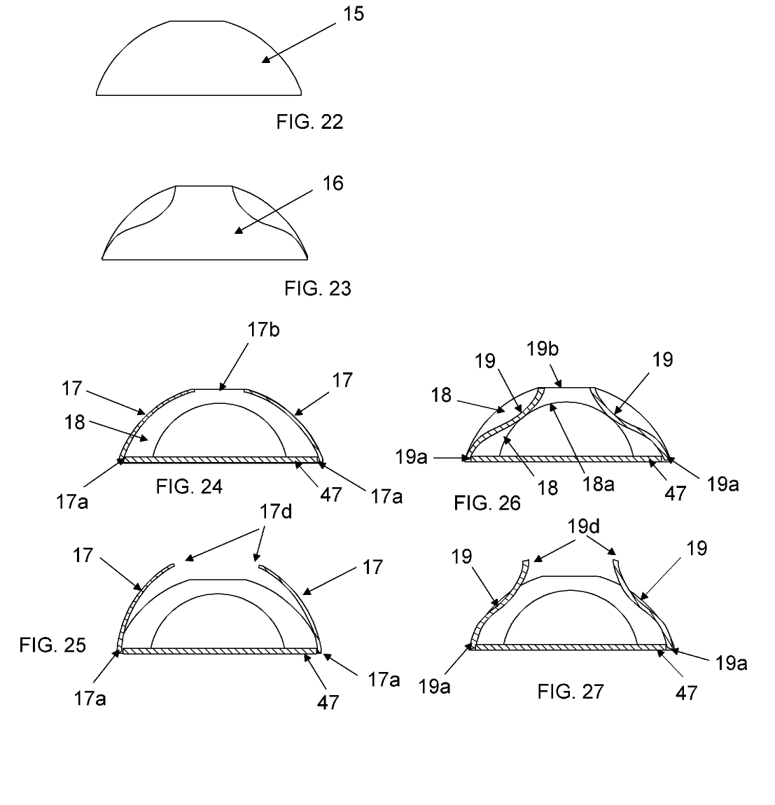

FIGS. 22 and 23 are respectively the views of FIGS. 18 and 19 for reference with the associated drawing figures.

FIG. 24 is cross-section 49 of FIG. 20 showing adjustable doors 17 in a closed position, thereby defining a slot opening 17b in the most narrow position for the invention device, thereby defining the smallest projection angle for its audio output. FIG. 25 is the cross-section of FIG. 24 showing adjustable doors 17 in a more open position, there by defining slot opening 17d and increasing the projection angle substantially as compared with that of FIG. 24 only for this diverter half.

FIG. 26 is cross-section 50 of FIG. 20 showing adjustable doors 19 in a closed position, thereby defining a slot opening 19b in the most narrow position for the invention device, thereby defining the smallest projection angle for its audio output. FIG. 27 is the cross-section of FIG. 26 showing adjustable doors 19 in a more open position, there by defining slot opening 19d and increasing the projection angle substantially as compared with that of FIG. 26 only for this diverter half.

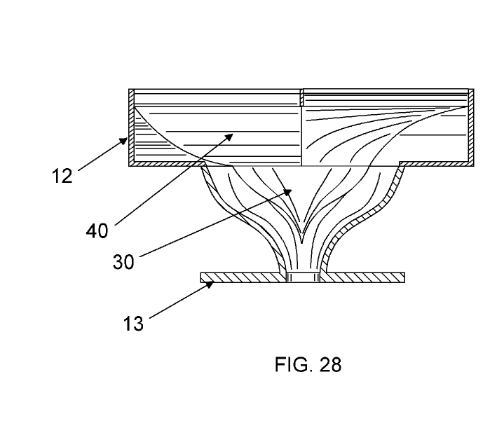

FIG. 28 is a cutaway view of FIG. 1.

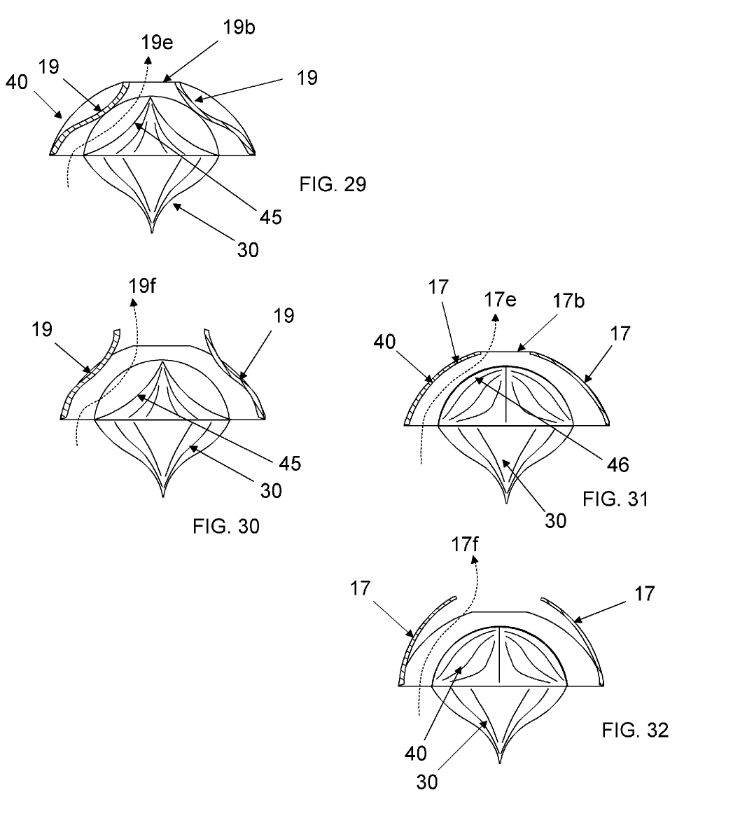

FIGS. 29, 30, 31 and 32 are respectively the views of FIGS. 26, 27, 24 and 25 adding a conical core 30 to the asymmetric diverter 40 and showing respectively audio output paths 19e, 19f, 17e and 17f in the space defined between the inside surfaces of the adjustable doors 19 and 17 and the outside surfaces 45 and 46 as that output emits through the adjustable slot openings.

FIG. 33 is the device of FIG. 29 showing the wide angle, short throw aspect of approximately half of the room output of the present invention, where sound wave portions divided in two by the asymmetric diverter 40 are re-combined along paths 17e but directed by virtue of the relatively more horizontal and opposing wave guiding of surfaces 46 and doors 17 to produce a sound angle 17g of about 90 to 180 degrees (at a preferred minimum of 5 kHz or higher frequency for the sound waves).

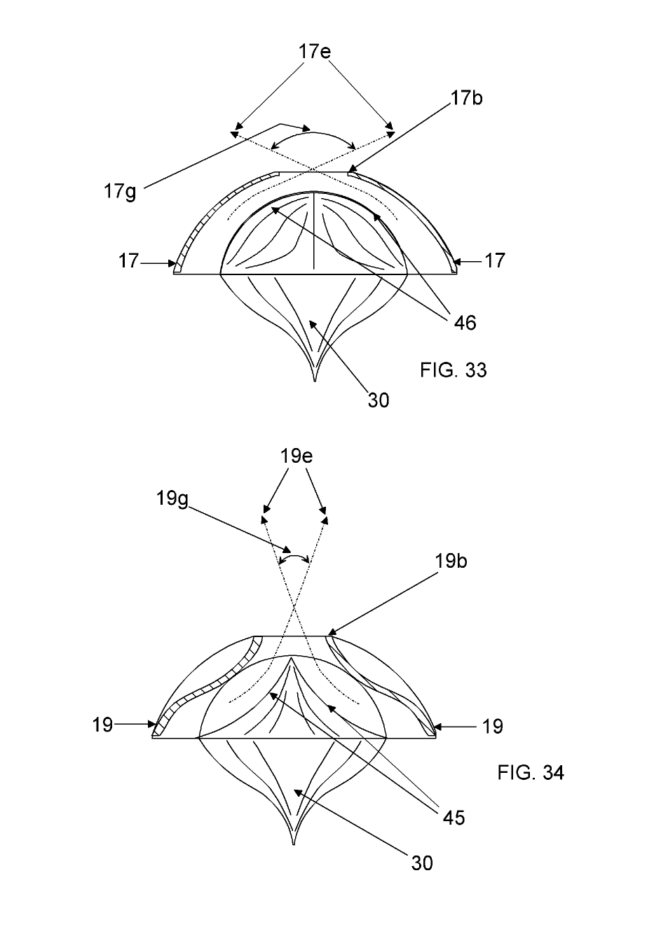

FIG. 34 is the device of FIG. 31 showing the narrow angle, long throw aspect of approximately half of the room output of the present invention, where sound wave portions divided in two by the asymmetric diverter 40 are re-combined along paths 19e but directed by virtue of the relatively more horizontal and opposing wave guiding of surfaces 46 and doors 17 to produce a sound angle 19g of about 20 to 120 degrees (at a preferred minimum of 5 kHz or higher frequency for the sound waves).

In a specific embodiment of the invention, a conical core comprises a cone angle of 41 degrees, height 156.55 mm, top diameter 117.40 mm, a concavity with a radian of 45° is close to the cone top, and a convexity with a radian of 45 degrees is close to the cone bottom. An asymmetrical diverter comprises diverter halves of an irregular truncated cone having a half truncated cone with a 45 degrees-radian concavity and a half truncated cone with a 45 degrees-radian convexity, where the truncated cone angle of the irregular truncated cone, its height is 60.04 mm, 2 symmetric one-quarter oval surfaces are formed with 45° radian are formed by inclined cutting of the half truncated cone, 2 symmetric one-quarter oval surfaces with 45 degrees radian are formed by inclined cutting of the half truncated cone, the arc ends of the one-quarter oval surfaces and one-quarter oval surfaces y8 extend to the small end of the irregular truncated cone, the round end's diameter of the conical core is the same as the small end's diameter of the asymmetric diverter, and the two diameters join together. A transition horn is a truncated cone with a bump surface and it holds and supports the conical core, where the transition horn's small end and big end respectively correspond to the cone top and bottom of the conical core; the bump surface radian of the transition horn is the same as that of the conical core, there is a 12.32-mm clearance between the inside surface of the transitional horn and conical core. The adjustable doors may be attached to the speaker housing by rotary rods, where the adjustable doors comprise to 2 one-quarter oval surfaces and the surface radian of the other adjustable doors is the same as that of the one-quarter oval surfaces, the adjustable door's width is 87.21 mm, length 125.67 mm and there is a 12.32-mm clearance between the inside surfaces of the adjustable doors and the outside surfaces of the asymmetric diverter.

In the invented asymmetric high frequency acoustic device, the radian angles of the conical core conical surfaces, inside surfaces of the transition horn, inside surfaces of the adjustable doors, and the outside surfaces of the asymmetric diverter may be chosen from within the range of from 15 degrees to 80 degrees, and more preferably from the range of from 30 degrees to 60 degrees

As for the application of the invented angle-adjustable asymmetric high frequency acoustic device, two such devices can be adjacent so that the slot openings in their closed position form a plane.

In the invention asymmetric high frequency acoustic device, the conical core may have a height of from 10 to 100 mm, a top diameter of from 10 to 100 mm, and a height of from 10 mm to 100 mm.

In the invention asymmetric high frequency acoustic device, the adjustable doors are preferably wider than the height of an outside surface of the diverter halves, have a length preferably greater than a radius of the asymmetric diverter at its divider plane. The above design options will sometimes present the skilled designer with considerable and wide ranges from which to choose appropriate apparatus and method modifications for the above examples. However, the objects of the present invention will still be obtained by that skilled designer applying such design options in an appropriate manner.

I claim:

1. An adjustable projection angle horn loudspeaker comprising:
(a) an acoustic driver adapted to produce high or mid-range frequency audio output and further connected with a throat of a transition horn;
(b) the transition horn comprising an acoustic horn with a throat opening, a mouth opening and intervening inside horn surface;
(c) a conical core supported within a horn space defined by the inside horn surface;
(d) an asymmetric diverter extending up and laterally from a top of the conical core, having dividing means for dividing the audio output into a first two parts, directing each of those first two parts to means for dividing each of those first two parts into a second two parts and recombining each of the second two parts into a recombined first part; and
(e) two opening slots, each defined by adjustable doors as part of a speaker housing enclosing the asymmetric diverter and in a position above the asymmetric diverter, each opening slot adapted to be opened to a more opened position and thereby increase a projection angle as compared with the adjustable doors in a more closed position.

2. The loudspeaker of claim 1 wherein dividing means comprises the speaker housing with a dividing wall that acoustically seals about a half length periphery of the asymmetric diverter.

3. The loudspeaker of claim 2 wherein the half length of the asymmetric diverter defines a division between a first diverter half and a second diverter half.

4. The loudspeaker of claim 3 wherein the first diverter half comprises two concave diverter surfaces aligned in an upward position.

5. The loudspeaker of claim 4 wherein the second diverter half comprises two convex diverter surfaces aligned in an upward position

6. The loudspeaker of claim 5 wherein inside surfaces of adjustable doors of the speaker housing spaced apart from diverter surfaces define four transmission path spaces that lead from an annular opening defined between a top rim of the transition horn and the conical core to one of the slot openings.

7. The loudspeaker of claim 6 wherein the inside surfaces of the adjustable doors spaced apart from the first diverter surfaces generally conform to the shape of those first diverter surfaces.

8. The loudspeaker of claim 7 wherein the inside surfaces of the adjustable doors spaced apart from the second diverter surfaces generally conform to the shape of those first diverter surfaces.

9. The loudspeaker of claim 8 wherein the inside surface of the transition horn generally conforms to the shape of an outside surface of the conical core.

10. The loudspeaker of claim 9 wherein the adjustable doors spaced apart from the first diverter surfaces are adjustable to provide a projection angle of from 20 degrees to 120 degrees.

11. The loudspeaker of claim 10 wherein the adjustable doors spaced apart from the second diverter surfaces are adjustable to provide a projection angle of from 90 degrees to 180 degrees independently of the projection angle of the audio output transmitted around the first diverter surfaces.

12. The loudspeaker of claim 9 wherein the adjustable doors spaced apart from the first diverter surfaces are adjustable to provide a projection angle of from 20 degrees to 120 degrees.
